(19) United States
(12) Patent Application Publication
(10) Pub. No.: US 2019/0372357 A1
(43) Pub. Date: Dec. 5, 2019

(54) REMOVABLE POWER SUPPLY FOR POWER AND DATA UNITS

(71) Applicants: Norman R. Byrne, Ada, MI (US); Jordan L. Shepherd, Grand Rapids, MI (US)

(72) Inventors: Norman R. Byrne, Ada, MI (US); Jordan L. Shepherd, Grand Rapids, MI (US)

(21) Appl. No.: 16/429,482

(22) Filed: Jun. 3, 2019

Related U.S. Application Data
(60) Provisional application No. 62/679,572, filed on Jun. 1, 2018.

(51) Int. Cl. H02J 7/00; H02J 7/02; A47B 97/00

(52) U.S. Cl. CPC H02J 7/007; H02J 7/02; H02J 2007/0062; A47B 97/00; H02J 7/0045

(57) ABSTRACT

An electrical power supply includes fixed-position electrical power unit mountable along a furniture article or the like, and a portable electrical power unit that is releasably mountable at the fixed-position unit for recharging the portable unit. The fixed-position unit includes a receiver with an electrical charging output. The portable unit is releasably mountable to the receiver and includes its own electrical receptacle and an onboard rechargeable power source. The onboard rechargeable power source is recharged by the charging output and supplies electrical power to the portable unit's receptacle at least when the portable unit is removed from the fixed-position unit. Optionally, the fixed-position electrical power unit includes a fixed electrical receptacle adjacent the portable unit when the portable unit is mounted at the fixed-position unit. A push-to-release mechanism may be provided to releasably secure the portable unit at the fixed-position unit.

### CROSS REFERENCE TO RELATED APPLICATION

The present claims the benefit of U.S. provisional application Ser. No. 62/679,572, filed Jun. 1, 2018, which is hereby incorporated herein by reference in its entirety.

### FIELD OF THE INVENTION

The present invention relates to electrical power supplies and, more particularly, to portable electrical power supplies having rechargeable batteries or the like.

### BACKGROUND OF THE INVENTION

The need or desire to incorporate electrical power outlets in different locations has increased as portable electronic devices such as mobile phones, portable media players, laptop computers, and the like have proliferated, since these devices often require charging of onboard batteries. Fixed-location electrical power outlets can supply power indefinitely, and are typically connected to main power sources associated with a building or vehicle. Portable battery-equipped electrical supplies are also available for limited charging of portable electronic devices, which are helpful when a user will not be positioned near a mains-powered outlet or wishes to at least partially recharge a portable electronic device while moving.

### SUMMARY OF THE INVENTION

The present invention provides a portable electrical power supply having an onboard rechargeable battery, capacitor, or other rechargeable or renewable electrical power source. The portable power supply is configured to fit into an opening or recess in a furniture-mounted power and/or data unit, where its onboard power source can be recharged, and where it can provide a continuous supply of electrical charging power to a portable electronic device for as long as power is supplied from a mains source to the power and/or data unit. The portable power supply can be removed from the power and/or data unit, which ceases the charging cycle of its onboard power source and allows the portable power supply to be carried by a user or placed in substantially any desired location, such as atop work surfaces, tables, desks, countertops and the like, or in a bag, vehicle, or pocket. While disconnected from the power and/or data unit, the portable power supply is capable of providing a limited amount of electrical energy for charging portable phones, handheld computers and media players, and other small electrical or electronic devices. The portable power supply can then be re-inserted into the power and/or data unit for recharging and/or supplying continuous power to one or more portable electronic devices.

The portable power supply may include several electrical connectors that allow multiple devices to be charged or supplied with power simultaneously, and may include a power switch to selectively energize and de-energize the electrical receptacles on the portable power supply. Optionally, the power unit includes a charge level indicator that provides a visual indication of the capacity remaining in the onboard power source.

In one form of the present invention, an electrical power supply includes a main electrical power unit and a portable electrical power unit. The main electrical power unit can be mounted along a furniture article, such as with a bracket. The portable electrical power unit is removably coupled to a receiver of the main electrical power unit, the receiver including an electrical charging output and a fixed electrical receptacle adjacent the receiver. The portable electrical power unit includes a portable electrical receptacle, an electrical charging receiver, and an onboard rechargeable power source. The charging receiver is positioned rearwardly from the portable electrical receptacle, and receives electrical power from the electrical charging output when the portable electrical power unit is engaged with the receiver. The rechargeable power source is recharged by the electrical charging receiver and energizes the electrical receptacle at least when the portable unit is removed from the main power unit. The electrical charging output is operable to recharge the onboard rechargeable power source when the portable electrical power unit is seated at the receiver.

According to one aspect, the electrical charging output includes a pair of electrical output contacts, and the electrical charging receiver includes a pair of electrical input contacts.

According to another aspect, there is an AC-to-DC power converter at the portable electrical power unit. The power converter receives high voltage AC power from the electrical output contacts and supplies low voltage DC power to at least one of the onboard rechargeable power source and the portable electrical receptacle.

According to yet another aspect, the receiver includes a cavity defined by a housing. The cavity has an open front end adjacent a front face of the fixed electrical receptacle.

According to still another aspect, the electrical output contacts are positioned along a rear surface defining a rear portion of the cavity, and the electrical input contacts are positioned along a rear surface of the portable electrical power unit. Optionally, the electrical input contacts are recessed into the rear surface of the portable electrical power unit. Optionally, the electrical output contacts or the electrical input contacts are spring-loaded and move in response to seating the portable electrical power unit in the cavity.

According to a further aspect, the receiver includes a cavity defined by a housing, with the cavity or the portable electrical power unit including a push-to-release mechanism that is used to partially eject the portable electrical power unit in response to a manual force applied to the front face in a rearward direction.

According to a still further aspect, when the portable electrical power unit is seated at the receiver, a front face of the portable electrical receptacle is coplanar with a front face of the fixed electrical receptacle.

In another form of the present invention, an electrical power supply includes a main electrical power unit that is mountable along a furniture article, and a portable electrical power unit removably coupled to the main power unit. The main power unit includes a receiver having an electrical charging output for recharging the portable power unit. The portable electrical power unit includes a low voltage DC electrical receptacle, an electrical charging receiver, and an onboard rechargeable power source such a battery. The electrical charging receiver is positioned rearwardly from the low voltage DC electrical receptacle and receives electrical power from the electrical charging output when the portable electrical power unit is engaged with the receiver. The onboard rechargeable power source is recharged by the electrical charging receiver, and also energizes the low voltage DC electrical receptacle. When the portable electrical power unit is seated at the receiver, the electrical charging output is operable to both recharge the onboard rechargeable power source and supply electrical power to the low voltage DC electrical receptacle. The portable electrical power unit is configured to electrically energize the low voltage DC electrical receptacle with the onboard rechargeable power source upon removal of the portable electrical power unit from the receiver.

Therefore, the electrical power supply of the present invention provides users with access to a continuous supply of electrical power at the main power unit, while also providing users with access to a limited supply of portable electrical power at a portable power unit. The portable power unit can be readily removed from the main power unit and carried any desired distance from the main power unit. The portable power unit can then be docked or coupled to a receiver of the main power unit for recharging and further use. While the portable power unit is coupled to the main power unit, the portable power unit's outlets remain available for use alongside the continuous-power outlets along the main power unit.

These and other objects, advantages, purposes and features of the present invention will become apparent upon review of the following specification in conjunction with the drawings.

### BRIEF DESCRIPTION OF THE DRAWINGS

FIG. 1 is a front perspective view of an electrical power unit and portable power supply in accordance with the present invention;

FIG. 2 is another front perspective view of the electrical power unit and portable power supply of FIG. 1, showing the portable power supply being removed from the electrical power unit;

FIG. 3 is a rear perspective view the portable power supply of FIG. 1, and showing the connection of a portable electronic device for charging;

FIG. 4 is a front perspective view of another electrical power unit and portable power supply in accordance with the present invention, depicting the insertion of the portable power unit;

FIG. 5 is another front perspective view of the electrical power unit and portable power supply of FIG. 4, showing the portable power unit fully inserted;

FIG. 6 is another front perspective view of the electrical power unit and portable power supply of FIG. 4, showing the portable power unit fully removed;

FIGS. 7A and 7B are front perspective views of another portable power supply and bracket mount in accordance with the present invention;

FIG. 8 is a right side elevation of the portable power supply and bracket mount of FIG. 7A, shown mounted to an edge of a work surface;

FIG. 9A is a front perspective view of another portable power supply and bracket mount in accordance with the present invention; and

FIG. 9B is a front perspective view of the portable power supply of FIG. 9A, shown removed from the bracket mount and depicting the insertion of a charging plug and wire of a portable electronic device.

### DESCRIPTION OF THE PREFERRED EMBODIMENTS

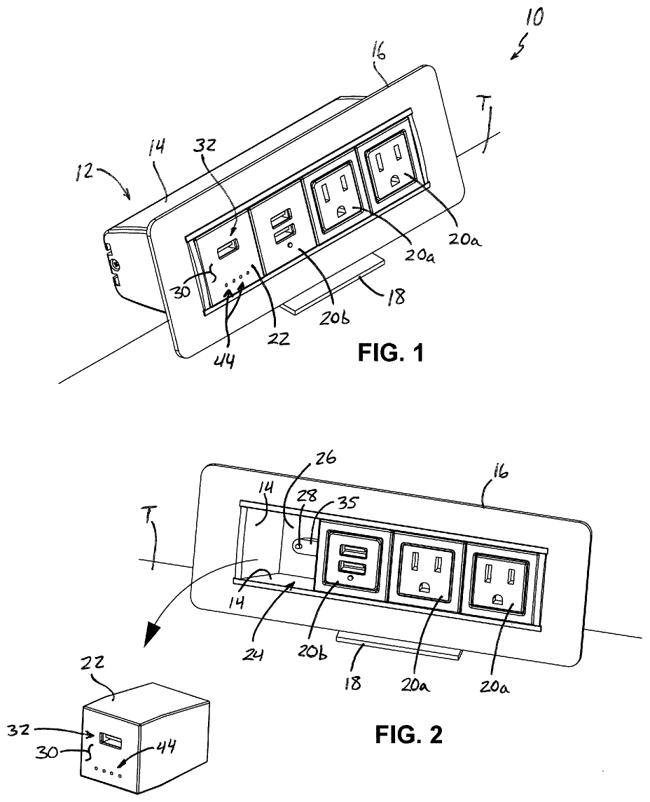

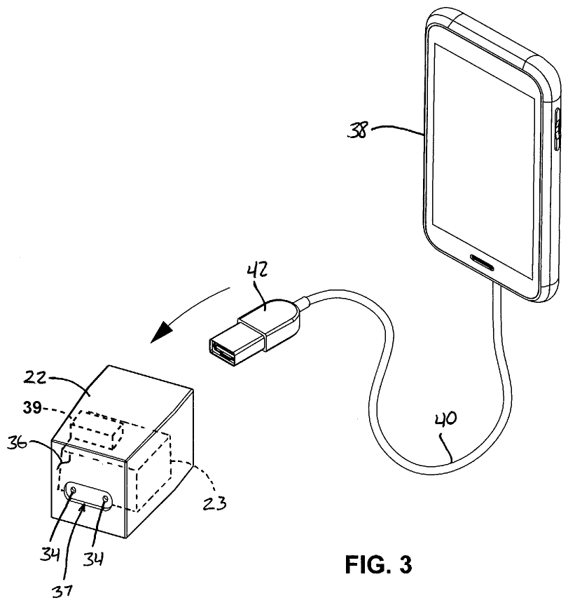

Referring now to the drawings and the illustrative embodiments depicted therein, an electrical power supply 10 includes a main generally fixed-location electrical power unit 12 having a rear housing 14, a front bezel 16, a mounting bracket 18, a plurality of electrical power receptacles arranged in a row, including high voltage AC receptacles 20a, low voltage DC receptacles 20b, and a portable electrical power unit 22 (FIG. 1). An electrical power cord (not shown) supplies continuous electrical power to the high voltage AC receptacles 20a and low voltage DC receptacles 20b, and provides charging power to the portable electrical power unit 22 when inserted into the housing 14, as long as the electrical power cord is connected to a mains power source, such as a wall or floor outlet of a building or work area, or in a vehicle. The portable electrical power unit 22 is detachable or removable from the electrical power unit 12, and has its own onboard rechargeable power source, such as a battery or capacitor 23 (FIG. 3), so that the portable electrical power unit 22 can supply a limited amount of charging power to portable electronic devices, even when the portable power unit 22 has been removed from the electrical power unit 12. This permits the portable power unit 22 to be carried to different locations as desired by a user for convenient on-the-go charging, and when the onboard rechargeable power source is depleted, the portable power unit 22 may be returned to the main electrical power unit 12 for recharging and immediate use.

Electrical power unit 12 may be coupled directly to a furniture article such as a table T via the bracket 18, such as shown in FIGS. 1 and 2. Although the electrical power unit 12 is generally described herein as being a “fixed-location” unit, the unit 12 may be considered somewhat portable, such as by releasing its bracket 18, disconnecting its power cord if needed, and relocating it to a new location where it can be re-mounted and reconnected to mains power. Various alternative mounting arrangements are envisioned, such as a power unit that is configured to rest on substantially any work surface and that may be repositioned as desired along the work surface, provided that there is sufficient power cord length available. It is further envisioned that a power unit may be mounted in an opening formed in a work surface, either in a static arrangement or in a “pop-up” configuration. Examples of various different types of power units that may be adapted to support a portable electrical power unit 22 are disclosed in commonly-owned U.S. Pat. Nos. 4,747,788; 5,351,173; 6,028,267; 6,379,182; 7,736,178; 8,444,432; 8,480,429; 8,690,590; 9,438,070; and 9,601,860, and U.S. Publication Nos. 2017/0317458 and 2017/0318609, the disclosures of which are all hereby incorporated herein by reference.

The electrical power unit 12 includes a receiver recess or cavity 24 defined in part by a rear wall 26 having a pair of electrical output contacts 28 (only one contact 28 is shown in FIG. 2), and with a front opening where the portable power unit 22 is inserted and removed. In the illustrated embodiment, electrical power unit 12 has one low voltage DC receptacle unit 20b adjacent receiver recess 24 and a pair of high voltage AC receptacles 20a on the other side of the DC receptacle unit 20b, opposite the receiver recess 24. It will be appreciated that various combinations and arrangements of fixed or hard-wired electrical power outlets are envisioned for the main electrical power unit 12, without departing from the spirit and scope of the present invention.

The portable electrical power unit 22 is insertable into the receiver recess 24 as shown in FIG. 1, and is removable from the receiver recess 24 as shown in FIG. 2. Portable power unit 22 includes a front face 30 where at least one electrical receptacle 32 is accessible, such as shown in FIGS. 1 and 2. In the illustrated embodiment, front face 30 is substantially flush or coplanar with the front faces of the electrical receptacles 20a, 20b when the portable power unit 22 is fully seated in the receiver recess 24. With this arrangement, if the front face 30 of the portable power unit is positioned forwardly relative to the front faces of the other receptacles 20a, 20b, this provides a clear visual indication that the portable power unit 22 is not fully seated and may not be receiving charging power from the output contacts 28.

In the illustrated embodiment, electrical receptacle 32 is a low voltage DC receptacle having a USB configuration, although it will be appreciated that substantially any other configuration of receptacle and electrical power output type (high or low voltage, AC or DC, direct-contact or wireless/non-contact) would be possible. Referring to FIG. 3, the portable electrical power unit 22 has a pair of electrical input contacts 34 along a rear surface 36. The input contacts 34 are positioned to engage the electrical output contacts 28 of the receiver recess 24 when the portable electrical power unit 22 is seated or engaged as shown in FIG. 1, so that output contacts 28 convey power to input contacts 34 when the main electrical power unit 12 is energized. The rear wall 26 of the electrical power unit 12 includes or supports an elongated protrusion 35 (FIG. 2) that extends forwardly from the plane of the rear wall 26, and is sized and shaped to receive a correspondingly-shaped elongated recess 37 (FIG. 3) formed in the rear surface 36 of the portable power unit 22. The elongated protrusion 35 supports the output contacts 28 and the elongated recess 37 surrounds or contains the input contacts 34. The elongated protrusion 35 and elongated recess 37 may include spring-loaded features and/or selective retaining features, such as to effect a push-to-engage and push-to-release feature for the portable power unit 22 at the main power unit 12.

The onboard battery 23 or other rechargeable power source of the portable electrical power unit 22 is recharged via the electrical input contacts 34, which may also energize the electrical receptacle 32 at the front face 30 even when the onboard battery 23 is completely depleted. Switching circuitry may be employed to direct power received at input contacts 34 to the onboard battery 23, to electrical receptacle 32, and optionally through an onboard AC-to-DC electrical power converter 39 (FIG. 3), and to direct power from the onboard battery 23 to the electrical receptacle 32 when the input contacts 34 are not energized, such as when the portable electrical power unit 22 has been removed from the receiver recess 24.

Optionally, the electrical output contacts 28 and/or the electrical input contacts 34 are spring-loaded to facilitate a good contact interface between the respective contacts when the portable power unit 22 is partially or fully seated in the receiver recess 24. Either set of contacts 28, 34 may be configured as spring-loaded “pogo-pins,” so that slight misalignments do not prevent corresponding contacts from contacting one another. It is further envisioned that the input contacts 34 may be recessed, such as within the elongated recess 37 (FIG. 3), to limit or prevent contact with a user's hand in a manner that could transfer oils or other contaminants to the contacts 34, and to permit the portable power unit 22 to be set flat on its rear surface 36 without resting on its contacts 34, which could otherwise potentially lead to damage or contamination of the contacts. Although direct-contact electrical contacts are primarily described and illustrated herein, it will be appreciated that wireless (contactless) charging technologies may be used instead, which would avoid the need for any exposed electrical contacts in the receiver recess or along the portable power unit.

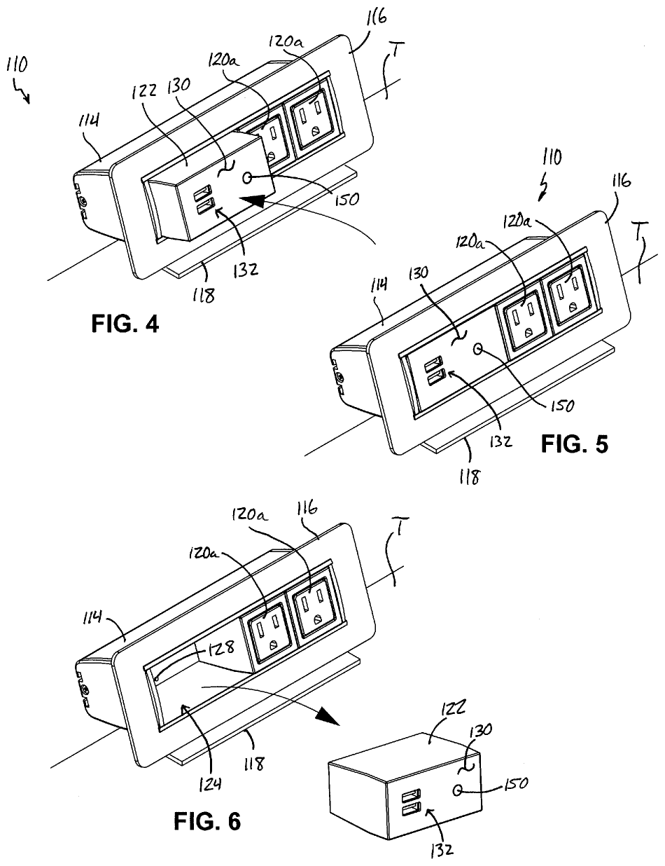

Optionally, a mechanical push-to-release mechanism is provided in the receiver recess 24, and is operable to at least partially eject the portable electrical power unit 22 in response to a manual force applied in a rearward direction to the front face 30 of the portable power unit 22 when the portable power unit is seated in the receiver recess 24. For example, the push-to-release mechanism may include a combination of springs and latches at or along the rear wall 26, or along other surfaces of the rear housing 14. One example of a push-to-release mechanism that may be adapted for receiving, retaining, and ejecting the portable unit 22, relative to the main unit 12, is disclosed in U.S. Pat. No. 3,402,379, entitled “Alternate Latch and Unlatch and Eject Mechanism Operated by Unidirectional Forces,” the disclosure of which is incorporated herein by reference. More compact push-to-release mechanisms are also available from numerous commercial sources. Once the portable power unit 22 is partially ejected, such as shown with a similar portable power unit 122 in FIG. 4, its front region can readily be grasped by a user at opposite sides of the front face 30. Optionally, recesses or protrusions may be provided at opposite sides of the portable power unit 22 to facilitate manually grasping the portable power unit 22 near its front face 30 for removal from the receiver recess 24.

It is further envisioned that instead of a push-to-release mechanism, an electromechanical actuator may be provided, which would detect the initial insertion of the portable power unit 22 and that draw the portable power unit 22 fully into the receiver recess 24. A separate button or a sensor that detects a force pressing against the front face 30 would then trigger the electromechanical mechanism to partially “eject” the portable power unit 22. Such electromechanical mechanisms are commonly known, for example, in the field of video cassette recorders (VCRs) and their corresponding video home system (VHS) cassettes. Although the push-to-release mechanism or eject mechanism is primarily described as being at the main electrical power unit 12, such mechanisms may instead be incorporated into the portable power unit 22 without departing from the spirit and scope of the present invention. Moreover, and instead of a mechanism for partially ejecting the portable power unit, it is further envisioned that a tab or other gripping surface may extend forwardly of the front surface 30, to enable a user to simply grasp and pull the portable power unit 22 out from the receiver recess 24. The portable power unit could then be manually re-seated in the receiver recess 24 by simply inserting the portable power unit and pushing with sufficient force to overcome any frictional resistance and to engage the corresponding contacts.

Once the portable power unit 22 is removed from the receiver recess 24 as shown in FIGS. 2 and 3, its electrical receptacle 32 may be used substantially anywhere to supply electrical power to a portable electronic device such as a smartphone 38 having a power cord 40 fitted with a compatible connector 42 (FIG. 3). The portable power unit 22 may be sufficiently small to be carried in a pocket, purse, or back, and thus is convenient for a user to carry to meetings, in a vehicle, or wherever a limited power supply is needed. Once the onboard battery power is depleted or the user returns to the vicinity of the main power unit 12, the portable power unit 22 may be returned to the receiver recess 24 for recharging, use, and storage. Optionally, and as shown in FIGS. 1 and 2, a power level indicator 44 is provided at the front face 30 of the portable power unit 22, which can display the remaining power capacity of the onboard battery 23 and/or the charging status of the onboard battery 23 by illuminating one or more individual lamps, and/or by changing the colors of the lamps at the indicator 44. Optionally, the power level indicator 44 may be selectively illuminated to indicate one or more of: power level reserve of the onboard battery 23, recharging status of the onboard battery 23 (charging/not charging), and whether or not the DC receptacle 32 is energized.

Referring now to FIGS. 4-7, another electrical power supply 110 includes a main electrical power unit 112 includes a rear housing 114, a front bezel 116, a mounting bracket 118, a pair of high voltage AC receptacles 120a, and a portable electrical power unit 122 that is removable from the rear housing 114 and replaceable at the housing 114 for recharging. Various components of electrical power supply 110 that are substantially similar to components of electrical power supply 10 are given like numerals by the addition of 100, such that the components of electrical power supply 110 may be readily understood with reference to the above discussion. Portable electrical power unit 122 includes a power switch 150 at its front face 130. The power switch 150 enables a user to selectively toggle the low voltage DC receptacles 132 between energized to de-energized states, as desired. The larger size of the electrical power unit 112 permits the use of a larger battery or other energy storage device, as compared to the battery 23 of the portable power unit 22, which in turn may facilitate the simultaneous use of two DC receptacles 132. Optionally, the power switch 150 may be selectively illuminated to indicate one or more of: power level reserve, recharging status of the onboard battery (charging/not charging), and whether or not the DC receptacles 132 are energized.

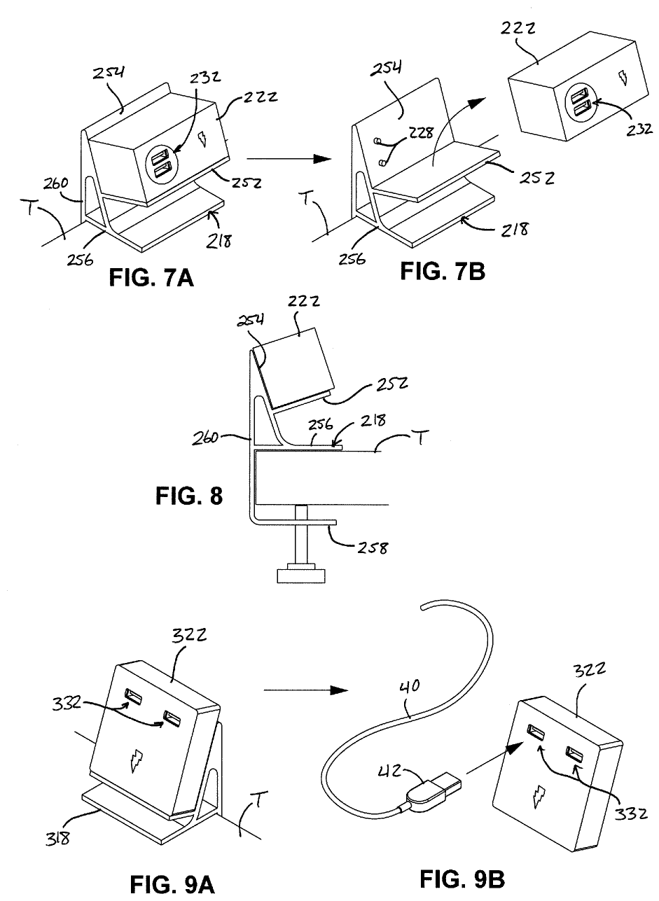

In an alternative arrangement, a portable electrical power unit 222 may be supported at a charging bracket 218 as shown in FIGS. 7A-8. The portable power unit 222 is supported at an elevated resting surface 252 and a backing surface 254 of the bracket 218. The backing surface 254 includes a pair of electrical output contacts 228 that are spaced above the elevated resting surface 252. The portable power unit 222 is substantially similar to the portable power units 22, 122 described above, including an onboard battery and the ability to energize low voltage DC receptacles 232 when positioned at the bracket 218 (FIGS. 7A and 8), or when removed from the bracket 218 (FIG. 8). A first horizontal wall 256 is spaced below the elevated resting surface 252 and engages a top surface of the table T, while a second horizontal wall 258 is spaced below the first wall 256 and configured to be positioned below the table T, such as shown in FIG. 8. A vertical back wall 260 extends downwardly from an upper end of the backing surface 254, connects to a rear end of the first horizontal wall 256, and downwardly below the table T where it connects to the second horizontal wall 258. A thumbscrew 262 is inserted through a threaded bore in the second horizontal wall 258, and can be manually turned to engage an underside of the table T as shown in FIG. 8, for securing the bracket 218 to the table T, and for accommodating tables having different thicknesses. It will be appreciated that different configurations of brackets may be used to secure the fixed-position power unit to a furniture article or room surface, which could be a table, desk, shelf, or countertop, a chair, sofa, or bed, a divider wall, or substantially any surface where a power outlet may be desired.

Different shapes of portable electrical power units with different arrangements of low voltage DC receptacles are envisioned, such as the portable electrical power unit 322 of FIGS. 9A and 9B. The portable electrical power unit 322 may be functionally identical to the portable power unit 222 described above, but with a square frontal shape and two low voltage DC outlet 332 in horizontally-spaced arrangement. Portable electrical power unit 322 is selectively supported on a bracket 318 that is dimensioned to support the power unit 322, and is otherwise identical to the bracket 218 described above.

Thus, the electrical power supply of the present invention provides a portable temporary-use power supply that can be stored, used, and recharged at a fixed-location furniture-mounted electrical power unit, such as may be provided along a desk, table, countertop, or other work surface. Upon removal from the main power unit, the portable power supply ceases charging and is available to supply limited power to other devices. The portable power supply can then be re-inserted into the power unit for recharging and also for supplying continuous power to one or more portable electronic devices.

Changes and modifications in the specifically-described embodiments may be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. An electrical power supply comprising:
an electrical power unit configured for mounting along a furniture article, said electrical power unit comprising a receiver having an electrical charging output and a fixed electrical receptacle adjacent said receiver;
a portable electrical power unit removably coupled to said receiver, said portable electrical power unit comprising:
a portable electrical receptacle;
an electrical charging receiver positioned rearwardly from said portable electrical receptacle and configured to receive electrical power from said electrical charging output when said portable electrical power unit is engaged with said receiver; and
an onboard rechargeable power source configured to be recharged via said electrical charging receiver and to energize said portable electrical receptacle;
wherein said electrical charging output is operable to recharge said onboard rechargeable power source when said portable electrical power unit is seated at said receiver, and said portable electrical power unit is configured to electrically energize said portable electrical receptacle with said onboard rechargeable power source upon removal of said portable electrical power unit from said receiver.

2. The electrical power supply of claim 1, wherein said electrical charging output comprises a pair of electrical output contacts, and wherein said electrical charging receiver comprises a pair of electrical input contacts.

3. The electrical power supply of claim 2, further comprising an AC-to-DC power converter at said portable electrical power unit, wherein said power converter is operable to receive high voltage AC power from said electrical output contacts and to supply low voltage DC power to at least one of said onboard rechargeable power source and said portable electrical receptacle.

4. The electrical power supply of claim 2, wherein said receiver comprises a cavity defined by a housing, said cavity having an open front end adjacent a front face of said fixed electrical receptacle.

5. The electrical power supply of claim 4, wherein said electrical output contacts are positioned along a rear surface defining a rear portion of said cavity, and said electrical input contacts are positioned along a rear surface of said portable electrical power unit.

6. The electrical power supply of claim 5, wherein said electrical input contacts are recessed into said rear surface of said portable electrical power unit.

7. The electrical power supply of claim 5, wherein said electrical output contacts or said electrical input contacts are spring-loaded and move in response to seating said portable electrical power unit in said cavity.

8. The electrical power supply of claim 1, wherein said receiver comprises a cavity defined by a housing, and wherein one of said cavity and said portable electrical power unit comprises a push-to-release mechanism configured to partially eject said portable electrical power unit in response to a manual force applied to said front face in a rearward direction.

9. The electrical power supply of claim 1, wherein when said portable electrical power unit is seated at said receiver, a front face of said portable electrical receptacle is coplanar with a front face of said fixed electrical receptacle.

10. An electrical power supply comprising:
an electrical power unit configured for mounting along a furniture article, said electrical power unit comprising a receiver having an electrical charging output;
a portable electrical power unit removably coupled to said receiver, said portable electrical power unit comprising:
a low voltage DC electrical receptacle;
an electrical charging receiver positioned rearwardly from said low voltage DC electrical receptacle and configured to receive electrical power from said electrical charging output when said portable electrical power unit is engaged with said receiver; and
an onboard rechargeable power source configured to be recharged via said electrical charging receiver and to energize said low voltage DC electrical receptacle;
wherein when said portable electrical power unit is seated at said receiver, said electrical charging output is operable to (i) recharge said onboard rechargeable power source and (ii) supply electrical power to said low voltage DC electrical receptacle; and
wherein said portable electrical power unit is configured to electrically energize said low voltage DC electrical receptacle with said onboard rechargeable power source upon removal of said portable electrical power unit from said receiver.

11. The electrical power supply of claim 10, wherein said receiver comprises a cavity defined by a housing, and wherein one of said cavity and said portable electrical power unit comprises a push-to-release mechanism configured to partially eject said portable electrical power unit in response to a manual force applied to said front face in a rearward direction.

12. An electrical power supply comprising:
an electrical power unit configured for mounting along a furniture article, said electrical power unit comprising a receiver cavity with a pair of electrical output contacts disposed in said receiver cavity, and a fixed electrical receptacle adjacent said receiver cavity;
a portable electrical power unit removably mounted in said receiver cavity, said portable electrical power unit comprising:
a front face providing access to a portable electrical receptacle;
a pair of electrical input contacts positioned rearwardly from said front face and configured to engage said electrical output contacts when said portable electrical power unit is engaged with said receiver cavity; and
an onboard rechargeable power source configured to be recharged via said electrical input contacts and to energize said portable electrical receptacle at said front face;
wherein said receiver cavity including said electrical output contacts is operable to recharge said onboard rechargeable power source when said portable electrical power unit is seated at said receiver cavity, and said portable electrical power unit is configured to electrically energize said portable electrical receptacle with said onboard rechargeable power source upon removal of said portable electrical power unit from said receiver cavity.

13. The electrical power supply of claim 12, wherein when said portable electrical power unit is seated at said receiver cavity, said front face and said fixed electrical receptacle of said electrical power unit are substantially coplanar.

14. The electrical power supply of claim 12, wherein said pair of electrical input contacts are positioned at a rear surface of said portable electrical power unit.

15. The electrical power supply of claim 12, wherein said pair of electrical output contacts are positioned at a rear surface of said receiver cavity and aligned for engagement with said pair of electrical input contacts.

16. The electrical power supply of claim 15, wherein said electrical output contacts or said electrical input contacts are spring-loaded and move in response to seating said portable electrical power unit in said receiver cavity.

17. The electrical power supply of claim 12, wherein said one of said receiver cavity and said portable electrical power unit comprises a push-to-release mechanism configured to partially eject said portable electrical power unit in response to a manual force applied to said front face in a rearward direction.

18. The electrical power supply of claim 12, further comprising an AC-to-DC power converter at said portable electrical power unit, wherein said power converter is operable to receive high voltage AC power from said electrical output contacts and to supply low voltage DC power to at least one of said onboard rechargeable power source and said portable electrical receptacle at said front face.

19. The electrical power supply of claim 18, wherein said portable electrical receptacle at said front face comprises a USB power receptacle.

20. The electrical power supply of claim 18, where said fixed electrical receptacle comprises a high voltage AC receptacle.
